(19) United States
(12) Patent Application Publication
(10) Pub. No.: US 2026/0242232 A1
(43) Pub. Date: Aug. 20, 2026

(54) A METHOD FOR PRODUCING A DOPED ALUMINOUS MATERIAL

(71) Applicant: LAVA BLUE LTD, Manuka, Australian Capital Territory (AU)

(72) Inventors: Rachel PEPPER, Manuka, Australian Capital Territory (AU); Sylvia TULLOCH, Manuka, Australian Capital Territory (AU); Sara COUPERTHWAITE, Manuka, Australian Capital Territory (AU); Wayde MARTENS, Manuka, Australian Capital Territory (AU); Michael MCCANN, Manuka, Australian Capital Territory (AU)

(21) Appl. No.: 19/156,161

(22) PCT Filed: Feb. 14, 2024
(86) PCT No.: PCT/AU2024/050094

§ 371 Date: Aug. 13, 2025

(30) Foreign Application Priority Data
Feb. 14, 2023 (AU) 2023900349

(51) Int. Cl. C01F 7/62; C01F 7/306; C01F 7/56; C09K 11/57; C09K 11/68

(52) U.S. Cl. CPC C01F 7/62; C01F 7/306; C01F 7/56; C09K 11/57; C09K 11/68; C01P 2002/52; C01P 2006/40

(57) ABSTRACT

A method for producing a doped-aluminous material. In particular, the present invention relates to a method for producing doped-aluminium oxyhydrochlorides and doped-alpha alumina.

The present document claims priority from AU2023900349 filed on 14 Feb. 2023 the contents of which are hereby incorporated by reference in their entirety. This document is related to applicants own WO2023235913A1 entitled A METHOD FOR PRODUCING AN ALUMINOUS MATERIAL the contents of which are hereby incorporated by reference in their entirety.

### TECHNICAL FIELD

The present disclosure relates to a method for producing a doped metal oxide or a doped metal oxyhydroxy chloride. For example, a method for producing a doped alumina or a doped aluminium oxyhydroxy chloride.

### BACKGROUND

Doping a metal oxide involves introducing impurities into the material to modify its properties, such as electrical conductivity or optical characteristics. Doped metal oxides, including aluminium based oxides, find wide-spread use as phosphors, pigments, catalysts, and lasing materials.

Methods to prepare such doped metal oxides are difficult to implement because it is a significant challenge to ensure homogeneous and atomic-scale dispersion of the dopant atom(s) within the metal oxide matrix. Traditional doping approaches include physical mixing of a slurry containing metal oxide particles, for instance alumina, and dopant particles, followed by extensive milling of the slurry, drying and then calcining; or mixing a dopant solution with a metal oxide powder in a series of steps involving multiple calcinations. As a result, traditional doping approaches involve multiple process steps increasing the complexity and energy requirements of the process. Other examples of approaches to doping of metal oxides in the literature include sol-gel processes using boehmite (AlOOH) as an alumina source, and processes that precipitate doped aluminium hydroxide from solutions of nitrate salts. However, the sol-gel and aluminium hydroxide approaches use expensive raw materials and require significant post-processing operations and hence cost.

There is need for an improved method for forming a doped metal oxide (or intermediate material) that ameliorates or at least overcomes some of the problems of the prior art, or which at least provides a useful alternative.

### SUMMARY OF INVENTION

According to an embodiment of the disclosure, there is provided a method for producing a doped material including:
providing a pregnant liquor comprising a soluble metal or soluble metal salt;
adding at least one dopant to the pregnant liquor to form a doped liquor;
subjecting the doped liquor to a crystallization process, the crystallization process including:
   adjusting the temperature of the doped liquor; and
   sparging the doped liquor with gaseous hydrochloric acid to form a slurry of doped metal chloride/hydrated metal chloride/hydrated metal chloride crystals;
separating the doped metal chloride/hydrated metal chloride crystals for the heating step; and
heating the doped metal chloride/hydrated metal chloride crystals to obtain the doped material.

In one or all embodiments, the pregnant liquor is provided ready made into the process. Alternatively, the present process can comprise steps involved in forming the pregnant liquor.

Depending on the temperatures in the heating step, the resultant doped material will be dried, heated, decomposed and or calcined. If the doped material is dried without calcining, the doped material will be an oxyhydroxy chloride. If the doped material is also calcined, the product will be a doped metal oxide.

In one or all embodiments, the metal in the feedstock material is aluminium. Thus, if the doped material is dried without calcining, the doped material can be an aluminium oxyhydroxy chloride. If the doped material is also calcined, the product will be a doped alumina.

The present doping method is possible because of the way in which the present alumina (or oxyhydroxy chloride intermediate) is formed. The significance lies in doping via a different chemical process, which may avoid traditional doping pathways with costly post-processing steps. This method involves the direct incorporation of dopants during crystallization of, and before conversion of the material to alumina. This is thought to circumvent high energy mixing and calcination stages in the traditional doping process. In-situ doping also has the advantage of providing greater control of wettability, particle size, chemical stability, porosity, and surface charge of doped alumina. In embodiments, this results in safer and higher performing materials. In one or all embodiments, the doped material can be used as a separator for Batteries The doped material formed by the present process may also find use in phosphors, pigments, catalysts, thermochromic sensors, and lasing materials. There may be other uses that are not yet known, in which the doped materials will find application. It will be understood that the use of the doped alumina may vary depending on the type and concentration of the dopant in the alumina lattice.

Advantageously, the doped material may have improved material properties such as porosity (e.g., due to improved ion transport, wettability) or have improved process economics (e.g., lowered energy requirements for material phase transitions). In relation to aluminium as an example, without wishing to be bound by theory, it is believed that the dopant may distort the alpha alumina lattice, and this distortion may lead to the above properties compared to the undoped alumina.

In one or all embodiments, the method can begin by dissolving feedstock material into a solvent. The feedstock material can be at least one metal, optionally in the form of a salt, that is dissolved into the solvent to form a pregnant liquor.

In an embodiment, the pregnant liquor is provided into the process with the feedstock material already solubilized therein. The pregnant liquor may have been formed by a third party and a different party may then undergo the doping process described herein. Notably, the method for forming the pregnant liquor is not limited and any means for obtaining a pregnant liquor is in scope. For the sake of exemplification only, the following provides some examples of how the pregnant liquor can be formed.

A suitable feedstock material is a substance which contains the metal of interest (such as aluminium) which is present as a compound which can be dissolved in the solvent being used (such as HCl).

Where a metal salt is used as the feedstock material, the soluble metal salt may be industrial reagent grade, laboratory reagent grade, guaranteed reagent grade, or analytical reagent grade, or produced from a variety of feedstocks. The soluble metal salt may be of any suitable form. For example, the soluble metal salt may be of particulate or solid form. For instance, the soluble metal salt may comprise crystals or a crystalline powder. There can be one salt, or there can be more than one soluble metal salt. At least one of the metal salts can be a metal chloride. In an embodiment, the soluble metal salt is a metal chloride. The metal chloride can be aluminium chloride hexahydrate (ACH).

The feedstock material can be an aluminium containing feedstock. In some embodiments, the aluminium-containing feedstock may be a source of alumina, aluminium hydroxide, aluminium metal, aluminium chloride hexahydrate, red mud, fly ash, aluminosilicates, kaolin, zeolite, feldspar, or the like. The aluminum metal can be in the form of aluminum foil.

In one or all embodiments, where the feedstock requires it, the aluminium-containing feedstock may be roasted. In this instance, it will be understood that the aluminium-containing feedstock may have been subjected to a heating process to reduce impurities or to thermally dehydroxylate the aluminium-containing feedstock prior to dissolution into the solvent to form the pregnant liquor.

Any suitable solvent may be used to solubilize the feedstock and prepare the pregnant liquor. The solvent should be sufficient to solubilize the chosen feedstock material into solution. For instance, the solvent may be an aqueous solution (such as e.g., water or an acidic solution), alcohol (such as e.g., ethanol), an organic solvent (such as e.g., glycerol (reactive) chloroform, carbon tetrachloride, ether, benzene or other hydrocarbon solvents). In some embodiments, the solvent may be ultra-pure water, demineralised water, or the like.

In one or all embodiments, the solvent may be sufficient to leach the metal such as aluminium from the feedstock. For instance, the solvent may be a strong acid such as hydrochloric acid, sulphuric acid, nitric acid or the like. The acid solvent may be of any suitable concentration. Generally, the concentration of acid solvent may be sufficient to solubilise the feedstock material.

In addition to the requirement that the solvent be sufficient to solubilize the feedstock material, the solvent should also be one in which HCl is soluble. As will become apparent from the teaching herein, one of the process steps involves sparging with HCl. Accordingly, the solvent must be one in which HCl is soluble so that sparging is successful. Furthermore, the metals/dopant used in the present process must also be soluble in the chosen solvent. The skilled person will be able to determine an appropriate solvent using their background knowledge, or through trial and error in order to arrive at a pregnant liquor as described herein.

The feedstock material may be added to the solvent in a stirred reaction vessel. In some embodiments, the reaction vessel is heated while the feedstock is added to the solvent.

In one or all embodiments, the aluminium-containing feedstock may be kaolin, wherein the kaolin may be roasted to form metakaolin and then leached with hydrochloric acid. In one or all embodiments, the aluminium-containing feedstock may be mining tailings or aluminium-containing waste material which may be leached using hydrochloric acid to extract aluminium.

In one or all embodiments, the aluminium containing feedstock is aluminium chloro hexahydrate (ACH) dissolved in the solvent hydrochloric acid.

The pregnant liquor comprises the feedstock material in the solvent. The pregnant liquor can have a cation concentration that is approaching saturation. The solution can be at saturation level or just below the saturation level. In one embodiment, the solution comprises saturation in the range of from about 60% to about 100%. A solution of metal/dopant which is approaching saturation means that crystallisation is more likely to be successful when adding HCl gas during sparging.

As the solution approaches saturation, the pregnant solution should not have any undissolved material in it. In one or all embodiments, where there is undissolved materials, the pregnant liquor can be treated to remove undissolved material. The treatment to remove undissolved material can be referred to as “polishing”. The pregnant liquor may be polished or clarified using any suitable technique known in the art. For example, the polishing step(s) may be sufficient to remove or reduce suspended solids such as fine precipitate, insoluble material, or the like. In some embodiments, the pregnant liquor may be polished or clarified using a filtration process and/or flocculants.

Where the feedstock material is aluminium in the form of aluminium chloride hexahydrate (ACH), the dissolution of metal chloride hexahydrate in the solvent may form a liquor of any suitable aluminium concentration. For example, the liquor may have a cation concentration of between about 30 g/L to about 80 g/L, between about 35 g/L to about 75 g/L, between about 40 g/L to about 70 g/L, or between about 45 g/L to about 65 g/L. The liquor may have a cation concentration of about 60 g/L. The 60 g/L is an example for aluminium, where the saturation would be approximately 90 g/L. It should be understood that for other metal starting materials, the g/L value will change. The g/L value will also change depending on the solvent.

If the solution is not concentrated enough concentration steps can be undertaken. The pregnant liquor may be concentrated using any suitable technique known in the art. Where ACH is the starting material, generally, the concentration technique may be sufficient to increase the aluminium in the pregnant liquor to its saturation point without precipitating the aluminium as aluminium chloride hexahydrate crystals. For instance, the pregnant liquor may be concentrated by heating the pregnant liquor to its boiling point, by evaporation by heating the pregnant liquor below its boiling point, or the like. The concentrated pregnant liquor may undergo a polishing step to remove insoluble contaminants such as silica or other precipitates.

According to one or all embodiments, the pregnant liquor comprising ACH and HCl may be concentrated to its saturation point by evaporation. The pregnant liquor comprising ACH and HCl may be concentrated by boiling the pregnant liquor at a temperature of between about 75° C. and about 130° C., between about 85° C. and about 120° C., for example, between about 95° C. and about 110° C. In one or all embodiments, the pregnant liquor may be concentrated by boiling the pregnant liquor at a temperature of between about 95° C. and about 110° C. In some embodiments, the pregnant liquor may be concentrated to an aluminium concentration of about 60,000 ppm. These temperature ranges may change when other metal feedstocks are dissolved in other solvents. However, based on this teaching the skilled person will be able to generalize how to form the pregnant liquor of the desired concentration.

Advantageously, concentrating the pregnant liquor may reduce the consumption of hydrogen chloride gas per unit of precipitated crystals during crystallization. Further, at the same given gas flow rate, the seed nucleation phase may be decreased relative to the growth phase, reducing the overall incorporation of impurities from the liquor which may be more readily captured at nucleation.

It is also noted here that the cation concentration of the pregnant liquor with respect to the metal may change depending on the concentration of dopant added as outlined below. If there is a high concentration of dopant added, the concentration of the metal may need to be decreased to keep everything in solution. The way to find the limit is if there is undissolved material after mixing all the components together.

At least one dopant may be added to the pregnant liquor to provide the doped liquor. The adding of the at least one dopant may occur before, simultaneously with, or sequentially after the dissolving of the soluble metal/metal salt in the solvent to provide the desired liquor composition prior to crystallization.

In one or all embodiments, the dopant is provided with the feedstock material. In one or all embodiments, the dopant is provided into the pregnant liquor. The dopant may be added to the solubilised feedstock material in a stirred reaction vessel. The dopant can be gradually added. The reaction vessel may be heated as the dopant is added to assist with the solubilization of the dopant metal salt.

When a material is doped, the dopant atoms are intentionally introduced into the crystal lattice of the original compound. The crystal lattice is the regular and repeating three-dimensional arrangement of atoms in a solid material. In semiconductor doping, dopant atoms replace some of the host atoms in the lattice structure. The dopant atoms may have different numbers of valence electrons compared to the host atoms, and this mismatch leads to changes in the electrical properties of the material.

Typically, the at least one dopant may comprise a metal compound soluble in given solvent. For example, the dopant may comprise an alkali metal compound, an alkaline earth metal compound, a transition metal compound, or a rare earth metal compound. In some embodiments, at least one dopant may include a transition metal compound or a rare earth metal such as a lanthanide compound.

For the process to work, the dopant must be soluble in the mixed dopant/metal solution. Furthermore, the dopant must remain in the doped metal oxide material after heat treatment. A dopant which is volatile under the chosen heating conditions will not be appropriate. A suitable dopant will be incorporated into the host metal material. The dopant should not form a secondary crystalline phase as detectable by a technique such as XRD on the resultant material. In relation to the last point, it is possible that small areas of concentrated dopant could be detected by certain techniques, and this could be interpreted as a secondary phase on the micro/nanoscale. However, as long as there is a substantially homogenous doped metal oxide material detected by techniques such as XRD, then the doping is considered a success.

The dopant may be provided as a metal salt. In embodiments in which the dopant is a metal salt, the metal salt may be a soluble metal salt. For example, the dopant is soluble in the solvent used to dissolve the feedstock material. The at least one dopant may be a metal chloride. By way of example only, the metal chloride can be a chloride of one or more of La, Mg, Ce, Co, Cr, Ni, Fe or Cu salts.

Advantageously, a metal chloride dopant is compatible with processes to prepare a mixed metal oxide material, such as the dissolution of aluminium chloride hexahydrate in aqueous solution and crystallization by sparging with gaseous hydrochloric acid. Further, use of metal chloride salts as dopants is thought to provide improved control over dopant incorporation into the final doped metal chloride intermediate product by preventing speciation in solution which might occur with other metal salts thereby minimizing impurities which would remain after calcination. In addition, metal chlorides release hydrochloric acid gas during processing of the oxide material which can be captured and recycled.

The concentration of the doped liquor will vary depending on many factors including the concentration of the feedstock material and the solvent system. Subject to the dopant selected the dopant concentration relative to the volume of liquor may be between about 10 mg/L to about 40,000 mg/L, between about 25 mg/L to about 7,500 mg/L, between about 50 mg/L to about 5,000 mg/L, between about 75 mg/L to about 2,500 mg/L, or between about 100 mg/L to about 2,000 mg/L, for example, between about 100 mg/L to about 1,000 mg/L. In one or all embodiments, the dopant concentration may be outside of these ranges if that is required to obtain a suitable final product.

Once doped, the doped liquor is subjected to a crystallization process. Generally, any suitable crystallization process may be used that is sufficient to precipitate out doped crystals and minimize the precipitation of impurities. Typically, the crystallization process may include adjusting a temperature of the doped liquor and sparging the doped liquor with gaseous hydrochloric acid to form a slurry of doped metal chloride/hydrated metal chloride crystals as discussed below.

The crystallization process includes adjusting the temperature of the doped liquor (upwards or downwards) and sparging the saturated doped liquor with gaseous hydrochloric acid to force crystallization of and form a slurry of crystals.

The doped liquor may be adjusted to any suitable temperature during crystallization, typically in a heated or cooled reaction vessel. For example, the doped liquor may be cooled to control the incorporation rate of the dopant into the product from crystallization.

Higher temperatures are thought to suppress nucleation and maximize the crystal growth phase. However, where a dopant is intended to be included, the idea is to encourage nucleation and shorten the crystal growth phase. This can be done by reducing the temperature of the doped liquor. Where aluminium is the metal of choice as the host material being doped, this cooling method works well since the solubility of aluminium chloride remains reasonably stable with temperature. The solution can be cooled without the risk of crystallization prior to sparging. However, this may not be the case universally so the adjustment of the temperature should be done carefully to avoid precipitation before sparging has commenced.

For ACH, the adjusted temperature range can be about −10° C. up to about 40° C. However, the temperature range is really dictated by the following factors: (i) The solution must remain a liquid before sparging. (ii) Metal and dopant must remain soluble and not crystallize due to the cold temperature.

The doped solution may be cooled using any suitable technique. For instance, the solution may be actively cooled, such as by being refrigerated or the like. Alternatively, the solution may be cooled by removing a heating source and allowing the solution to cool to ambient temperature over a period of time. Advantageously, cooling of the solution also improves hydrogen chloride recovery.

The solution may be agitated during cooling. In use, it is envisaged that agitating the solution during cooling may assist in avoiding formation of aggregates and assists in the formation of smaller particles.

The cooled doped liquor is sparged with gaseous hydrochloric acid. Generally, the sparging of the doped liquor may be sufficient to form a slurry of doped-metal crystals. Any suitable type of gaseous hydrochloric acid may be used for sparging. For instance, the gaseous hydrochloric acid may be purified.

The doped liquor may be sparged with gaseous hydrochloric acid until the saturated solution attains a hydrochloric acid concentration suitable for the crystallization of the doped metal chloride product. The end point can be flexible depending on the outcome desired. Generally, sparging is undertaken until HCl approaches saturation in the solution. In some instances, however, there may be some benefit to stopping the crystallization prematurely since this favors the nucleation vs crystal growth stages. Sparging can be ceased at any point after visual crystal formation.

The precipitate crystal slurry may be separated using any suitable technique known in the art. For example, the separation technique may be sufficient to separate the precipitate from the spent liquor. For instance, the separation technique may include gravity settling clarifiers, sedimentation, decanting, centrifugation, filtration, or the like.

The precipitate may be washed to separate the doped crystals from impurities in the precipitate. The precipitate may be washed with any suitable wash liquid. Generally, the wash liquid may be sufficient to redissolve soluble contaminants or the like from the doped crystals. The wash liquid may be sufficient to also displace the entrained contaminated supernatant and replace with the less-contaminated wash liquid.

In some embodiments, the wash liquid may be hydrochloric acid, aluminium chloride hexahydrate in a hydrochloric acid solution, or spent liquor.

In one or all embodiments, the method further include one or more pyrolysis steps selected from the group consisting of:
(a) drying the doped-metal chloride/hydrated metal chloride crystals, optionally under at least a partial vacuum;
(b) heating the dried doped-metal chloride/hydrated metal chloride crystals, optionally under controlled air flow; and
(c) decomposing the heated doped-metal chloride/hydrated metal chloride crystals,
wherein the above one or more pyrolysis steps occur after the step of separating the doped-metal chloride/hydrated metal chloride crystals from the spent liquor and before the step of calcining the doped-metal chloride/hydrated metal chloride crystals.

In the method there can be:
drying of the doped-metal chloride/hydrated metal chloride crystals, optionally under at least a partial vacuum; and
heating the doped-metal chloride hexahydrate crystals optionally under controlled air flow before calcining of the doped-metal chloride/hydrated metal chloride crystals to obtain the doped metal oxide.

The drying of the doped-metal chloride/hydrated metal chloride crystals can, in one or all embodiments, be undertaken under at least a partial vacuum. This occurs after the separating the doped-metal chloride/hydrated metal chloride crystals from the spent liquor and before the heating of the doped-metal chloride/hydrated metal chloride crystals under the controlled air flow.

Typically, the doped-metal chloride/hydrated metal chloride crystals may be dried under a partial vacuum to aid in the evaporation of liquids by reducing the boiling point of liquids.

The doped-metal chloride/hydrated metal chloride crystals may be dried at any temperature that removes solvent. In one or all embodiment, the temperature is in the range of from about 50° C. and about 150° C., or between about 60° C. and about 140° C., such as between about 80° C. and about 130° C.

In one or all embodiments, the doped-metal chloride/hydrated metal chloride crystals comprise residual chloride levels of about 30% by weight to about 45% by weight of the doped-metal chloride/hydrated metal chloride crystals after the step of drying.

In one or all embodiments, the doped-metal chloride/hydrated metal chloride crystals comprise substantially no residual moisture content.

In use it is envisaged that low temperature heating of doped-metal chloride/hydrated metal chloride crystals under at least a partial vacuum may assist in reducing entrained liquor, including water, within the crystals to produce stabilised dehydrated doped-metal chloride/hydrated metal chloride crystals.

Advantageously, low temperature drying under a partial vacuum to reduce entrained liquor before the crystals are dried at higher temperatures may improve the energy efficiency of the drying stages as compared to drying only at higher temperatures.

The doped-metal chloride/hydrated metal chloride crystals may be dried using any suitable technique known in the art. The drying may be undertaken with or without a vacuum. For example, using a microwave drier, a vacuum drier, a microwave-assisted vacuum drier, or any other suitable indirect drying techniques under vacuum.

The method may further include:
heating the doped-metal chloride/hydrated metal chloride crystals under controlled air flow before calcining the doped-metal chloride/hydrated metal chloride crystals to obtain the doped metal oxide.

The step of heating the doped-metal chloride/hydrated metal chloride crystals under controlled air flow may occur after the separating of the doped-metal chloride/hydrated metal chloride crystals from a spent liquor and before the calcining of the doped-metal chloride hexahydrate crystals.

The heating of the doped-metal chloride hexahydrate crystals under controlled air flow produces doped-metal oxyhydroxychlorides. The term “metal oxyhydroxy chloride” refers to an intermediate product in the formation of metal oxides formed by heating metal chloride/hydrated metal chloride crystals at low temperatures. Metal oxyhydroxy chlorides typically comprise a mixture of metal oxychloride species with a low concentration of free chlorides, which are generally dry, chemically stable and with good flowing properties.

Where ACH is used as a starting material, the doped-aluminium chloride crystals may be heated under controlled air flow conditions using any suitable technique that dries the doped-aluminium chloride and produces doped-aluminium oxyhydroxychlorides. For example, the dried doped-metal chloride/hydrated metal chloride crystals may be heated in a forced air-drying oven, a flash dryer, or a fluidised bed dryer. Suitably, under the controlled air flow conditions, air is directed into a vessel such that it contacts the doped-metal chloride/hydrated metal chloride crystals and assists in removal of water and hydrochloric acid vapour from the vessel.

The dried doped-metal chloride/hydrated metal chloride crystals may be heated in a heated vessel under a heated and/or dry air flow. Generally, the doped-metal chloride/hydrated metal chloride crystals may be gradually heated to a hold temperature, typically using a ramp rate (rate of temperature change over time) that reaches the hold temperature as quickly as possible. As used herein, the term “hold temperature” may refer to a substantially constant temperature or a range of temperatures to which a material is heated to and held at during a step of a process. Any suitable hold temperature may be used. For example, for the crystals, the hold temperature may be between about 150° C. and about 300° C., between about 160° C. and about 280° C., or between about 170° C. and about 250° C., for example between about 180° C. and about 230° C. Likewise, any suitable ramp rate may be used to reach the hold temperature. For example, the ramp rate may be about 10° C. per minute, about 20° C. per minute, about 30° C. per minute, about 40° C. per minute, about 50° C. per minute, about 75° C. per minute, about 100° C. per minute or greater. The doped-metal chloride/hydrated metal chloride crystals may be heated at the hold temperature for any suitable period of time. For example, the crystals may be heated at the hold temperature for at least about 30 minutes, at least 60 minutes, at least about 90 minutes, at least about 120 minutes, at least about 150 minutes, at least about 180 minutes, at least about 210 minutes, at least about 240 minutes, at least about 270 minutes, at least about 300 minutes, at least about 330 minutes or even at least about 360 minutes. The doped-metal chloride/hydrated metal chloride crystals may be agitated while being heated under the controlled air flow conditions.

In use, it is envisaged that agitating the crystals while heating may break up any aggregates formed and assist in particle size reduction of the crystals. In addition, heating the doped-metal chloride/hydrated metal chloride crystals under controlled air flow conditions may assist in deagglomeration and/or particle size reduction of the crystals through the introduction of high velocity air into the vessel. In other embodiments, the doped-metal chloride/hydrated metal chloride crystals may undergo a particle size reduction process before, during, or after heating under the controlled air flow conditions.

The method may further include:
decomposing the doped-metal chloride/hydrated metal chloride crystals before crystals are calcined.

The doped-metal chloride/hydrated metal chloride crystals may be decomposed by means of a rotary kiln or fluidised bed at high temperatures to transition phases, for instance when the doped material is alumina, such as doped-gamma alumina and doped-amorphous alumina before being calcined at high temperatures to obtain primarily doped-alpha alumina.

Generally, the decomposition temperature may be sufficient to remove the majority of the remaining chlorides. For example, the decomposition temperature may be between about 600° C. and about 1,800° C., such as between about 700° C. and about 1,400° C. or between about 800° C. and about 1,000° C.

Where ACH is the staring material and doped alumina oxide is the desired product, the doped-metal chloride/hydrated metal chloride crystals may be heated at a decomposition temperature of about 800° C. The crystals may be heated at the decomposition temperature for a period of at least about 30 minutes, at least 60 minutes, at least about 90 minutes, at least about 120 minutes, at least about 150 minutes, at least about 180 minutes, at least about 210 minutes, at least about 240 minutes, at least about 270 minutes, at least about 300 minutes, at least about 330 minutes, at least about 360 minutes, or more. These times and temperatures may vary depending on the metal and the dopant.

In some embodiments, the decomposing step may comprise controlling the humidity in the vessel. It is envisaged that controlling the humidity of the vessel may assist in promoting chloride removal prior to calcination.

In some embodiments, the doped-metal oxide formed by the decomposing comprises residual chloride levels of less than about 1.5% by weight, for example less than about 1.0% by weight, for example less than about 0.4% by weight of the doped-metal oxide. Advantageously, lowering the residual chloride levels of the doped-metal oxide reduces a potential cause of corrosion in the vessel during calcination. As a result, this allows a wider selection of materials used in the construction of the vessels, kilns, calciners, and the like in which the pyrolysis occurs.

In addition, splitting the decomposition process into a lower temperature heating and a higher temperature decomposition stage effectively splits the process across two pieces of equipment that can each be designed for a tighter range of operating conditions thereby reducing the stress placed on each piece of equipment and potential equipment failure.

The doped-metal chloride/hydrated metal chloride crystals can be heated through a number of steps as described and then calcined at a temperature of between about 800° C. and about 1,750° C. to obtain a doped-metal oxide material.

Following calcining, the doped-metal oxide may comprise at least about 70%, at least 75%, at least 80%, at least 85%, at least 90%, at least 95%, at least 99% of the feedstock material metal with the remainder being the doped metal atoms.

The doped-metal chloride/hydrated metal chloride crystals may be heated at any temperature and for any length of time that results in calcination of the material. The term “calcining” means a high temperature heating process whereby a mineral-containing material is converted to its oxide form. It is also commonly referred to as ignition, heating, decomposition, pyrolysis or hydro-pyrolysis. As an example only, the calcination temperature can be between about 800° C. and about 1,350° C. or between about 950° C. and about 1,300° C., such as between about 1,100° C. and about 1,250° C. The heating may occur for any suitable period of time. For example, the crystals may be heated for a period of at least about 30 minutes, at least 60 minutes, at least about 90 minutes, at least about 120 minutes, at least about 150 minutes, at least about 180 minutes, at least about 210 minutes, at least about 240 minutes, or more.

The calcined doped-metal oxide comprises the final oxide phase of the metal and at least one dopant. The dopant may comprise about 1 mg/kg to about 1,000, 10,000 or 20,000 mg/kg of the metal oxide.

Any of the features described herein can be combined in any combination with any one or more of the other features described herein within the scope of the invention.

### BRIEF DESCRIPTION OF THE FIGURES

Exemplary features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a method of producing a doped aluminous material according to an embodiment of the invention;

FIG. 2 illustrates a method of producing a doped aluminous material according to another embodiment of the invention;

FIG. 3 illustrates a method of producing a doped aluminous material according to yet another embodiment of the invention; and

FIG. 4 illustrates a method of producing a doped aluminous material according to a further embodiment of the invention.

FIG. 5 is a graph showing Cr induced luminescence in doped alumina (excitation 525 nm).

FIG. 6 is a graph showing Mn induced luminescence in doped alumina (excitation 525 nm).

### DETAILED DESCRIPTION OF EMBODIMENTS OF THE INVENTION

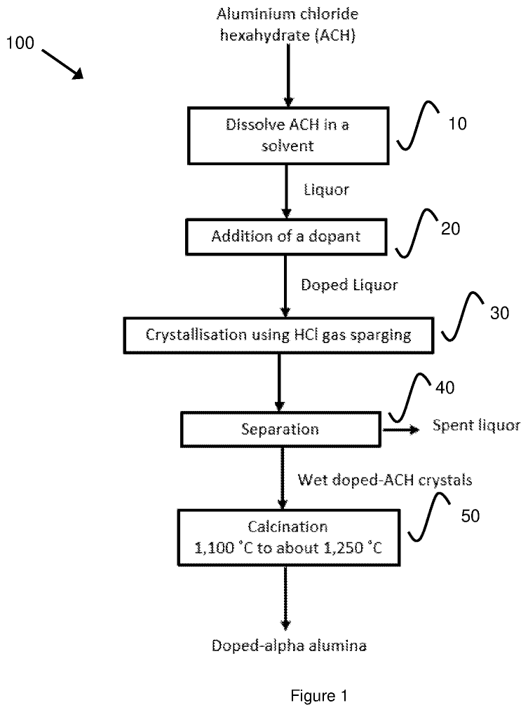

A method (100) for producing a doped-aluminous material as shown in FIG. 1 is described in detail. The doped-aluminous material comprises doped alumina.

At step 10, aluminium chloride hexahydrate (ACH) is dissolved in a solvent to provide a liquor. In this embodiment, the solvent comprises a 10% hydrochloric acid solution. The liquor that results has an aluminium concentration of about 60 g/L.

At step 20, at least one dopant is added to the liquor to form a doped liquor. The at least one dopant is a transition metal chloride. The doped liquor comprises between about 100 to about 1,000 mg of the at least one dopant per litre of liquor.

At step 30, the doped liquor is subjected to a crystallization process. The crystallization process includes adjusting the temperature of the doped liquor. The doped liquor temperature is adjusted to be in the range of from about 0 ° C. to about 20° C. The doped liquor is sparged with gaseous hydrochloric acid to form a slurry of doped-aluminium chloride crystals. The sparging can be during the temperature change or after the temperature change. The doped-liquor is sparged with gaseous hydrochloric acid to attain a concentration of between about 30 % to about 35 % hydrochloric acid in the doped liquor in order to precipitate out at least some and preferably all of the doped-aluminium chloride crystals.

At step 40, the slurry of doped-aluminium chloride crystals that formed as a precipitate is separated to provide doped-aluminium chloride crystals and a spent liquor. In this embodiment, the doped-aluminium chloride crystals are separated from the spent liquor using vacuum filtration. The crystals are washed with either hydrochloric acid solution or an aluminium chloride hexahydrate-hydrochloric acid solution.

At step 50, the doped-aluminium chloride hexahydrate crystals are calcined at a temperature between about 1100° C. and about 1250° C., to obtain the doped-aluminous material, preferably primarily doped-alpha alumina.

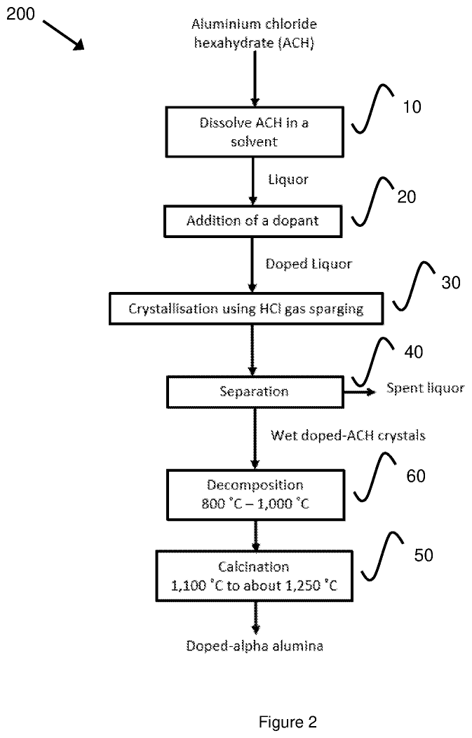

Referring to FIG. 2, another method (200) of producing a doped-aluminous material is now described in detail. In this embodiment, the doped-aluminous material comprises doped alumina. However, the method (200) as illustrated in FIG. 2 and as described in the specification is the same as the method (100) illustrated in FIG. 1 and described in the specification with the exception that the doped-aluminous material is subjected to an additional processing step 60.

Steps 10, 20, 30, 40, and 50 in the method as illustrated in FIG. 2 correspond to steps 10, 20, 30, 40, and 50 in the method as illustrated in FIG. 1. At step 60, the doped-aluminium chloride crystals are decomposed at a temperature of between about 800° C. and about 1000° C. before the doped-aluminium chloride crystals are calcined at a temperature of between about 1100° C. and about 1250° C. to obtain primarily doped-alpha alumina. The step of decomposing the doped-aluminium chloride crystals forms primarily an amorphous alumina.

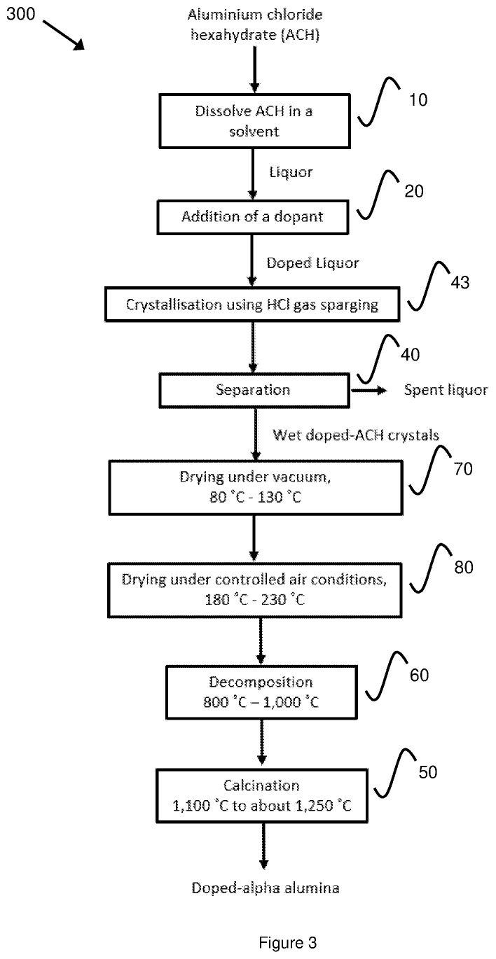

Referring to FIG. 3, another method (300) of producing a doped-aluminous material is now described in detail. In this embodiment, the doped-aluminous material comprises doped-alpha alumina. Again, the method (300) as illustrated in FIG. 3 and described in the specification is the same as the method illustrated in FIG. 2 and described in the specification with the exception that the doped-aluminous material is subjected to additional processing steps 70 and 80.

Steps 10, 20, 30, 40, 50 and 60 in the method as illustrated in FIG. 3 correspond to steps 10, 20, 30, 40, 50 and 60 in the method as illustrated in FIG. 2. After separation step 50, a drying step 70 is used followed by a heating step 80. At step 70, the doped-aluminium chloride crystals are dried under at least a partial vacuum. The doped-aluminium chloride crystals are dried at a temperature of between about 80° C. and 130° C. under at least a partial vacuum.

After the doped-aluminium chloride crystals are dried under at least a partial vacuum, heating step 80 is used. At step 80, the doped-aluminium chloride crystals are heated under controlled air flow at a temperature of between about 180° C. and about 230° C. The doped-aluminium chloride crystals are agitated while being heated under the controlled air flow conditions. The low temperature heating of doped-aluminium chloride crystals, which may be undertaken under at least a partial vacuum, is thought to assist in reducing entrained liquor, including water, within the crystals to produce stabilised dehydrated doped-aluminium chloride. The stabilised dehydrated doped-aluminium chloride is then be dried to obtain an intermediate product in the form of doped-aluminium oxyhydroxychlorides.

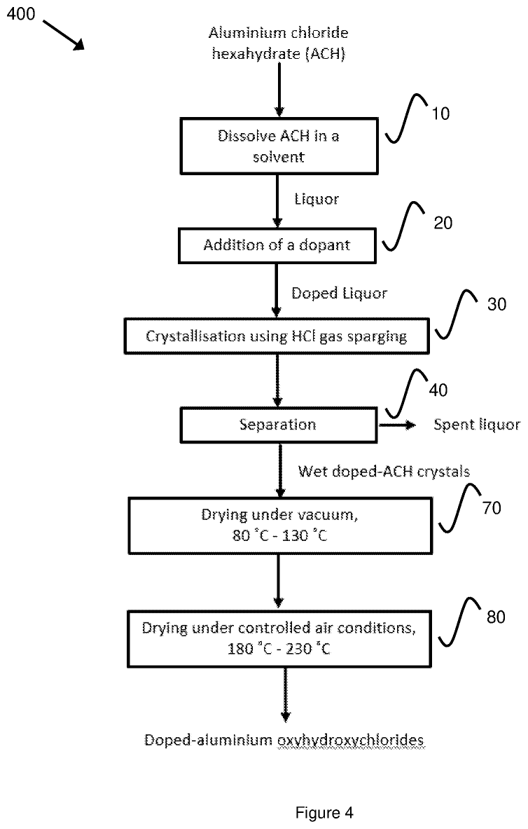

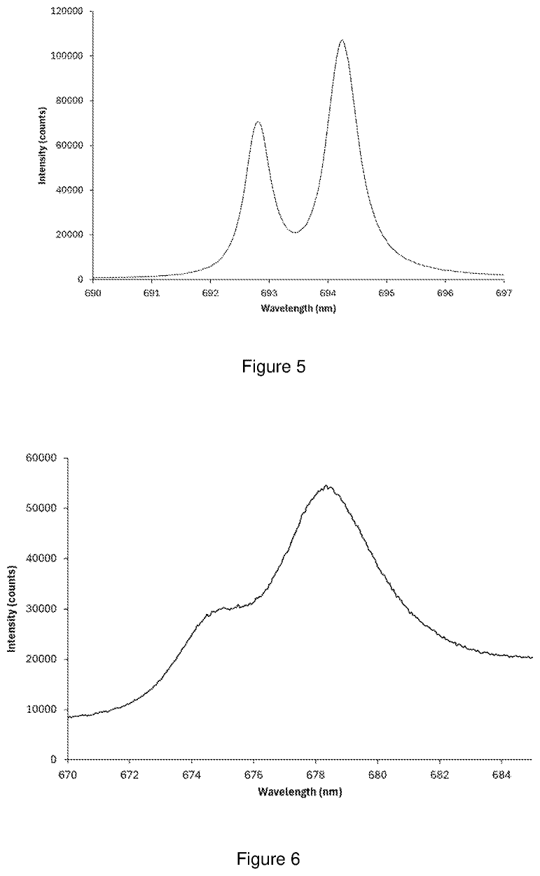

Referring to FIG. 4, another method (400) of producing a doped-aluminous material is now described in detail. In this embodiment, the doped-aluminous material comprises doped-aluminium oxyhydrochlorides. Again, the method (400) as illustrated in FIG. 4 and described in the specification is entirely encompassed within the method (300) illustrated in FIG. 3.

Steps 10, 20, 30 and 40 in the method (400) as illustrated in FIG. 4 correspond to steps 10, 20, 30 and 40 in the method as illustrated in FIG. 1. Steps 70 and 80 in the method (400) as illustrated in FIG. 4 correspond to steps 70 and 80 in the method (300) as illustrated in FIG. 3. The end product of FIG. 4 is an intermediate product aluminium oxyhydroxychlorides of FIG. 3.

### EXAMPLES

The following examples of embodiments of the invention are exemplary only and are not intended to be limiting.

### Cr Doped Alumina:

Pregnant solution was prepared from commercial AlCl₃·6H₂O and CrCl₃·6H₂O and contained 60 g/L Al, 0.5 g/L Cr. Doped aluminium chloride was crystallised through HCl gas sparging at 0° C. until saturation with respect to HCl (30-32% HCl). The doped aluminium chloride was decomposed at 800° C., 2 hrs, in air, then calcined at 1250° C.

Resulting alumina had Cr concentration of 950 mg/kg and exhibited new properties including narrow band red fluorescence at 693 and 694 nm, and an expansion of the alumina crystal lattice.

### Fe Doped Alumina:

Pregnant solution was prepared from commercial AlCl₃·6H₂O and FeCl₃·6H₂O and contained 60 g/L Al, 0.35 g/L Fe. Doped aluminium chloride was crystallised through HCl gas sparging at 0° C. until saturation with respect to HCl (30-32% HCl).

The doped aluminium chloride was decomposed at 800° C., 2 hrs, in air, then calcined at 1250° C.

Resulting alumina had Fe concentration of 530 mg/kg and exhibited new properties including a reduction in band gap to 4.4 eV, compared to 8.8 eV for pure alumina.

### Mn Doped Alumina:

Pregnant solution was prepared from commercial AlCl₃·6H₂O and MnCl₂·4H₂O and contained 55 g/L Al, 0.7 g/L Mn. Doped aluminium chloride was crystallised through HCl gas sparging at 0° C. until saturation with respect to HCl (30-32% HCl). The doped aluminium chloride was decomposed at 800° C., 2 hrs, in air, then calcined at 1250° C.

Resulting alumina had Mn concentration of 240 mg/kg and exhibited new properties including luminescence at 678 nm.

It is to be understood that, if any prior art publication is referred to herein, such reference does not constitute an admission that the publication forms a part of the common general knowledge in the art, in Australia or any other country.

Any promises made in the present description should be understood to relate to some embodiments of the invention and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for producing a doped material including:
providing a pregnant liquor comprising a soluble metal or soluble metal salt;
adding at least one dopant to the pregnant liquor to form a doped liquor;
subjecting the doped liquor to a crystallization process, the crystallization process including:
adjusting the temperature of the doped liquor; and
sparging the doped liquor with gaseous hydrochloric acid to form a slurry of doped metal chloride crystals or doped hydrated metal chloride crystals;
increasing the temperature of the doped metal chloride crystals or doped hydrated metal chloride crystals to obtain the doped material.

2. The method according to claim 1, wherein the soluble metal or soluble metal salt is aluminium or aluminium salt.

3. The method according to claim 2, wherein the soluble metal or soluble metal salt is aluminium chloride hexahydrate.

4. The method according to claim 1, wherein the method further includes the steps of preparing the pregnant liquor comprising dissolving a soluble metal or soluble metal salt as a feedstock into a solvent.

5. The method according to claim 1, wherein the dopant is selected from an alkali metal compound, an alkaline earth metal compound, a transition metal compound, or a rare earth metal compound such as a lanthanide compound.

6. The method according to claim 5, wherein the dopant is a chloride of an alkali metal compound, an alkaline earth metal compound, a transition metal compound, or a rare earth metal compound such as a lanthanide compound.

7. The method according to claim 1, wherein the step of adjusting the temperature of the doped liquor comprises cooling the doped liquor.

8. The method according to claim 1, wherein the step of increasing the temperature of the doped metal chloride crystals or doped hydrated metal chloride crystals includes:
drying the doped metal chloride crystals or doped hydrated metal chloride crystals under at least a partial vacuum.

9. The method according to claim 8, wherein the step of increasing the temperature of the doped metal chloride crystals or the doped hydrated metal chloride crystals includes:
heating the dried doped metal chloride crystals or doped hydrated metal chloride crystals under controlled air flow to form a doped-metal oxyhydroxy chloride compound.

10. The method according to claim 9, wherein the step of increasing the temperature of the doped metal chloride crystals or doped hydrated metal chloride crystals includes:
calcining the doped metal chloride crystals or doped hydrated metal chloride crystals to form a doped metal oxide.

11. The method according to claim 10, wherein the metal oxide is an alumina oxide.

12. (canceled)

13. (canceled)

14. (canceled)
